(19) United States
(12) Patent Application Publication
(10) Pub. No.: US 2007/0165002 A1
(43) Pub. Date: Jul. 19, 2007

(54) USER INTERFACE FOR AN ELECTRONIC DEVICE

(75) Inventor: Tomas Karl-Axel Wassingbo, Lund (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SONY ERICSSON MOBILE COMMUNICATIONS AB, Lund (SE)

(21) Appl. No.: 11/306,867

(22) Filed: Jan. 13, 2006

(51) Int. Cl. G06F 3/02

(52) U.S. Cl. 345/169

(57) ABSTRACT

A user input interface for an electronic device, comprising a keyboard with a plurality of keys arranged in proximity to each other. Each key comprises an input detector sensitive to detect user activation, such as a pressure switch. A sensor in each key is configured to generate a signal responsive to a sensed level of user-induced influence on the key, such as a degree of coverage of or contact with the key. A control unit is then configured to compare the generated signals for a number of keys simultaneously activated by a user, in order to determine which one of the simultaneously activated is intended to be input by the user.

### FIELD OF THE INVENTION

The present invention relates to a user interface for an electronic device, and is particularly suitable for compact electronic devices, such as mobile phones, pocket computers, and electronic media players or recorders. More specifically, the invention relates to an improvement in small size input interfaces having keys or buttons arranged in close proximity to each other, such that the user experiences a risk of activating more than one key or the wrong key. This problem is overcome by a sensor arrangement, where a level of user influence on an activated key is measured and evaluated for determination of which key is really intended to be input by the user.

### BACKGROUND

The use of electronic devices with control input capabilities, such as computers, mobile phones, and audio/video equipment, has had enormous development in the world in the last decades. Traditionally, keyboards or keypads have been used for entering data and control commands into such electronic equipment. Auxiliary input means include joysticks or jog balls, and voice-controlled systems. Data output from the electronic devices is mainly provided by means of displays, on which images, text, and numbers are visualized.

A lot of effort has been made in making smaller electronic devices, in particular for portable use, such as mobile phones, laptop computers, Personal Digital Assistants (PDA), mp3 players, and so on. Much help has been obtained from the miniaturization of electronic components and the development of more efficient batteries. In mobile communications, the communication systems have gone from analogue to digital, and at the same time the dimensions of the communication terminals have gone from briefcase size to the pocket size phones of today, in only a couple of decades. Still today, mobile phones are getting smaller and smaller and the size is generally considered to be an important factor for the end customer.

Regarding mobile phones as well as portable computers and media players, the end users have a number of conflicting requirements. Basically, the device should be as small and light-weight as possible. Furthermore, it should provide more and more advanced functions, have a long battery time, and have a user-friendly interface. Still, there is only so much space in an electronic device, and in order to be competitive the elements of the devised must be carefully packaged.

In recent years, the use of touch-sensitive devices for input interfaces has increased rapidly. A trend within the fields of electronic equipment is to implement larger displays serving as data output interfaces, which is particularly interesting with radio transmission schemes which make it possible to transmit and present video. Furthermore, such displays are also often touch-sensitive and serve as data input interfaces, preferably operated by means of a pen-like stylus. Touch-sensitive input means are also used without combination with output means, such as in the iPOD MP3 player from Apple®. This particular state of the art device is devised with a ring-shaped input area, which may be used for scrolling menus by moving a finger in contact with the surface. By dividing the ring-shaped surface in sector portions, each sector portion may represent one step in a scrolling function.

Touch-sensitive input devices may e.g. work with capacitive technology, where a particular portion of an input surface comprises an electrode of a conductive material. As a user's finger touches or comes sufficiently near the electrode, the capacitance of the electrode changes, which change is picked up by a capacitance sensing circuit. Resistive solutions have also been provided, using a flexible electrode sheet suspended to a rigid electrode sheet with an intermediate frame spacer.

### SUMMARY OF THE INVENTION

As electronic devices become smaller, the available space for providing plural keys on the input interfaces tends to decrease. In the context of the present invention, keys of a user interface are meant to denote separate areas or elements capable of being activated by a user. As such, a key may be a single element devised to be activated for input by pressing, or simply by touching. Alternatively, a key may be a specific area of a touch-sensitive surface, wherein detected touch within that specific area is registered as activation of that key.

One trend within the field of compact electronic devices is to decrease the number of keys. This is specifically the case for e.g. mp3 players. However, for certain types of electronic devices a user input interface with a plurality of keys is still desired. This is typically the case for electronic devices on which alpha-numeric symbols are frequently input, e.g. for the purpose of writing documents, messaging, internet browsing and emailing. The standard mobile phone user interface comprises 12 keys, including 0-9, * and #. Furthermore, each key holds an alternative set of input symbols, where letters ABC are input using the number 2 key, and so on. As displays tend to cover an increasingly larger area of the terminal, the space left for the input keys decreases, which means that the size of the keys decreases, and/or the distance between the keys. The risk of not pressing or otherwise activating the intended key thereby increases. Furthermore, some compact electronic devices include even more keys, such as a full QWERTY keyboard or a modified version of the same. The key size and the space between the keys is then even more critical.

It is therefore an object of the present invention to provide a user input interface for electronic devices, such as mobile phones, PDA's, laptop computers, and media players, which minimizes the risk of a user activating the wrong button.

According to a first aspect, this object is fulfilled by a user interface for an electronic device, comprising:
a plurality of keys arranged in proximity to each other, each key comprising an input detector sensitive to detect user activation;
a sensor configured to generate a signal responsive to a sensed level of user-induced influence on each one of the keys;
a control unit configured to compare the generated signals for a number of keys simultaneously activated by a user, and to determine which one of said number of keys is user-selected for input based on the comparison.

In one embodiment, the sensor comprises a touch-sensitive element in each key and a detection circuit configured to generate a signal which is dependent on a sensed level of user-induced contact to the key.

In one embodiment, the detection circuit is configured to generate a signal which is dependent on a sensed impedance between the touch-sensitive element and an object applied in contact with the key.

In one embodiment, the detection circuit is configured to generate a signal which is dependent on a sensed capacitance between the touch-sensitive element and an object applied in contact with the key.

In one embodiment, the control unit is configured to determine that the user has selected the key generating a signal representing the highest capacitance.

In one embodiment, the detection circuit is configured to generate a signal which is dependent on a sensed electric resistance between the touch-sensitive element and an object applied in contact with the key.

In one embodiment, control unit is configured to determine that the user has selected the key generating a signal representing the lowest electrical resistance.

In one embodiment, the sensor comprises a light-sensitive element in each key and a detection circuit configured to generate a signal which is dependent on a sensed level of user-induced coverage of the light-sensitive element.

In one embodiment, control unit is configured to determine that the user has selected the key generating a signal representing the largest extent of coverage.

In one embodiment, the sensor further comprises a light source, and where the light-sensitive element in each key is configured to sense light originating from the light source reflected in a surface covering the light-sensitive element.

In one embodiment, the sensor comprises a pressure-sensitive element in each key and a detection circuit configured to generate a signal which is dependent on a sensed level of user-induced pressure to the key.

In one embodiment, the control unit is configured to determine that the user has selected the key generating a signal representing the largest pressure.

In one embodiment, the input detector comprises a switch operable by pressing the key, and a circuit connected to the switch configured to detect user activation.

In one embodiment, the input detector comprises a switch operable by touching a touch-sensitive element of the key, and a circuit connected to the switch configured to detect user activation.

In one embodiment, the control unit is configured to determine that the key for which the signal has an extreme value among the number of keys is the one key user-selected for input.

In one embodiment, the control unit is configured to send a user input signal to the electronic device representing the key determined to be user-selected for activation.

According to a second aspect, the invention relates to an interface for an electronic device, comprising:
a plurality of keys arranged in proximity to each other, each key comprising an input detector sensitive to detect user activation;
a touch-sensitive element in each one of the keys, configured to generate a signal responsive to a sensed level of contact between each key and a user touching the key;
a control unit configured to compare the generated signals for a number of keys simultaneously activated by a user, and to determine which one of said number of keys is user-selected for input based on the comparison.

According to a third aspect, the invention relates to an interface for an electronic device, comprising:
a plurality of keys arranged in proximity to each other, each key comprising an input detector sensitive to detect user activation;
a light-sensitive element in each one of the keys, configured to generate a signal responsive to a sensed level of coverage by a user of each key;
a control unit configured to compare the generated signals for a number of keys simultaneously activated by a user, and to determine which one of said number of keys is user-selected for input based on the comparison.

According to a fourth aspect, the invention relates to an interface for an electronic device, comprising:
a plurality of keys arranged in proximity to each other, each key comprising an input detector sensitive to detect user activation;
a pressure-sensitive element in each key, configured to generate a signal responsive to a sensed level of pressure applied by a user on the key;
a control unit configured to compare the generated signals for a number of keys simultaneously activated by a user, and to determine which one of said number of keys is user-selected for input based on the comparison.

According to a fifth aspect, the invention relates to a method for operating a user interface for an electronic device, comprising:
detecting simultaneous user activation of a number of keys arranged in proximity to each other;
generating a signal responsive to a sensed level of user-induced influence on each one of the number of keys;
comparing the generated signals for the number of keys simultaneously activated by a user; and
determining which one of said number of keys is user-selected for input based on the comparison.

In one embodiment, the method comprises the step of:
comparing a magnitude level for the generated signals, the magnitude level for each key representing a level of contact between the user and the key.

In one embodiment, the method comprises the step of:
comparing a magnitude level for the generated signals, the magnitude level for each key representing a level of coverage of the user on the key.

### BRIEF DESCRIPTION OF THE DRAWINGS

The present invention will now be described in more detail with reference to preferred embodiments, given only by way of example and illustrated in the accompanying drawings, in which:

FIG. 1 schematically illustrates an electronic device in the form of a mobile phone, on which an input interface comprising a number of keys is arranged, for user input by pressing or touching;

FIG. 2 schematically illustrates a portion of a keyboard forming a user interface for an electronic device, and indicates schematically how a number of keys are influenced by a user;

FIG. 3 schematically illustrates signals generated for each of the keys illustrated in FIG. 2, responsive to the level of user influence;

FIG. 4 schematically illustrates an embodiment of a key of an input interface, comprising a sensor configured to sense a level of user-induced influence on the key, electrically or optically;

FIG. 5 schematically illustrates an alternative embodiment where each key comprises a plurality of sensor elements, each being capable to sense the presence of user-induced influence;

FIG. 6 schematically illustrates an optical solution for a key of a user interface, configured to sense a level of user-induced influence by determining a degree of shading the key;

FIG. 7 schematically illustrates another optical solution for a key of a user interface, configured to sense a level reflected light from a user or other object held against or adjacent to the key;

FIG. 8 schematically illustrates an embodiment of a key of an input interface, comprising a switch operable by pressing the key for detecting input activation by a user, and an optical sensor for detecting a degree of user-induced influence on the key;

FIG. 9 schematically illustrates an embodiment of a key of an input interface, comprising a switch operable by touching a touch-sensitive element of the key for detecting input activation by a user, where the touch-sensitive element is also responsive to sense a degree of user-induced influence on the key;

FIG. 10 schematically illustrates an embodiment of a key of an input interface, comprising a switch operable by pressing the key for detecting input activation by a user, and an pressure sensor for detecting a degree of user-induced influence on the key.

### DETAILED DESCRIPTION OF PREFERRED EMBODIMENTS

The present description relates to the field of input interfaces for electronic devices, such as data communication and processing devices, radio communication terminals, digital cameras, camcorders, game consoles, and media players. The electronic devices referred to in this disclosure includes all mobile equipment devised for radio communication with a radio station, which radio station also may be mobile terminal or e.g. a stationary base station. Consequently, the term terminal includes data communication devices such as mobile telephones, pagers, communicators, electronic organizers, smartphones, PDA:s (Personal Digital Assistants) and DECT terminals (Digital Enhanced Cordless Telephony). The invention is also applicable to computers, e.g. laptops, which are included in the electronic device used herein. Although the invention is particularly suitable for portable devices, where low weight and small dimensions are relevant parameters, the invention may equally well be included in stationary devices, such as desktop computers, wire-bound telephones, hi-fi equipment, and so on. Furthermore, it should be emphasized that the term comprising or comprises, when used in this description and in the appended claims to indicate included features, elements or steps, is in no way to be interpreted as excluding the presence of other features elements or steps than those expressly stated.

Preferred embodiments will now be described with reference to the accompanying drawings.

FIG. 1 illustrates an electronic device in the form of a mobile communication terminal 10, such as mobile telephone. Terminal 10 comprises a housing 11 and a user interface including a keypad or keyboard 12 and a display 13. Typically, the terminal 10 also includes an audio interface including a microphone and a speaker, radio transceiver circuitry, an antenna, a battery, and a microprocessor system including associated software and data memory for radio communication, all contained within housing 11. The specific function and design of the terminal as such is of little importance to the invention, and will therefore not be described in any greater detail. The terminal of FIG. 1 has a standard input interface comprising digits 0-9, * and #, as well as a number of control keys including a navigation tool. The layout of keys in an input interface as shown in FIG. 1 may well be very dense, with little or no space between each two adjacent keys. The invention as described in more detail below is advantageously incorporated in a user input interface as that of FIG. 1. However, the following description will be directed to traditional typewriter style keyboard, which also commonly used in electronic devices, as an alternative to the common alpha-numeric keypad as shown in FIG. 1, or as an additional keypad, such as in the Sony Ericsson P910i. The input interface of electronic device 10 is configured to be operated by using a finger 14, or e.g. a stylus (not shown).

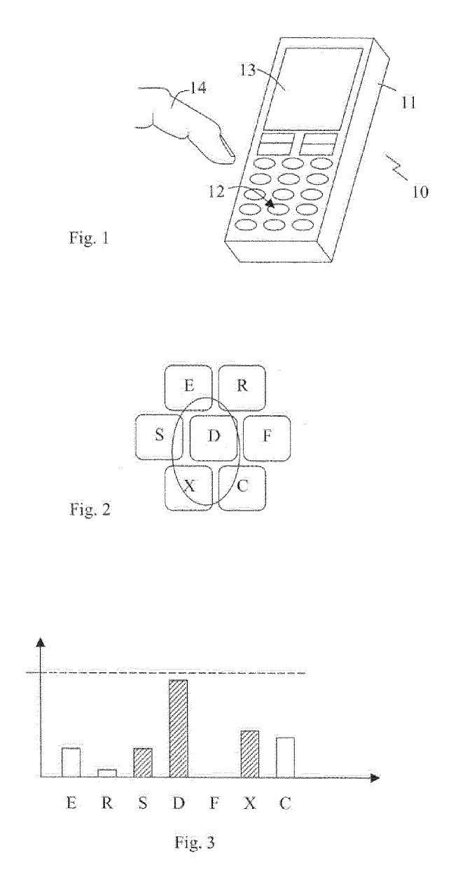

A standard typewriter style keyboard, or QWERTY keyboard, the keys may be arranged in straight lines and columns, or with each line of keys slightly shifted in relation to the next line. FIG. 2 illustrates a number of keys within the plurality of keys normally included in a QWERTY keyboard. Furthermore, an oval line illustrates schematically a user's fingertip placed on the keys of the keyboard. Now, due to the relative size of the fingertip compared to the size of the keys and the space between the keys, more than one key will be touched or at least covered. In accordance with the invention, each key of the keyboard comprises an input detector sensitive to detect user activation. The input detector may e.g. be a switch, operable by pressing according to the established art. Alternatively, the input detector may include a touch-sensitive element, which may be capacitive or resistive. In such a case, the activation necessary for registering input is mere contact, or in the case of a resistive touch-sensitive element a slight pressure. In addition to the input detector, each key includes or makes use of a sensor configured to generate a signal responsive to a sensed level of user-induced influence on each one of the keys. As will be described below, this sensor function may employ the same detector as the input detector, or a separate sensor element or elements. A functional difference exists between the input detector and the sensor, though. Whereas the input detector registers activation or no activation, the sensor is devised to register at least two levels of influence on each key besides no influence. In some of the embodiments that will be described below, the sensor is adapted to sense a level of coverage of each key by a user, or a level of contact, in a level between 0 and 100%, either on a continuous scale or a stepwise scale. In another embodiment a level of pressure applied to the key is measured by the sensor.

So, the input interface of the invention detects input on a number of keys, and is also configured to detect to which degree the user has influenced the keys on which input has been detected. This is illustrated in an exemplary diagram in FIG. 3, which corresponds to the scenario of FIG. 2. Each column represents the signal level generated from each one of the keys marked with the corresponding symbol E, R, S, D, F, X and C. As can be seen in FIG. 2, the user has covered almost the entire area of key D, and parts of the adjacent keys except for key F. The sensor included in key D operates to generate a signal having a characteristic responsive to the degree of coverage of key D. In FIG. 3, the signal generated from the sensor in key D has a magnitude representing the level of coverage of the area of key D, which is close to the 100% coverage level indicated by the dashed line. However, as the user presses key D, keys S and X are also accidentally pressed. The level of influence, which can be sensed for each key, is therefore also sensed for the input-detected keys S and X. The corresponding signals generated for these two keys are also shown in FIG. 3, where the magnitude of the signals are represented for the keys in question and correspond to the area portion covered on the keys. Merely to indicate the function of the coverage-sensing mechanism, the level of influence is indicated for all of the keys illustrated in FIG. 2. However, it is only relevant to determine the level of influence for the keys for which input have been detected, which are the ones marked out in FIG. 3.

Based on the signals generated representing the level of influence on the keys on which input is detected, a comparison is made in a control unit, typically a microprocessor system running an application software program. the control unit is configured to compare the generated signals for the keys simultaneously activated by a user, in this case S, D, and X, to determine which one is user-selected for input. In a preferred embodiment, the key from which the signal having the largest magnitude is generated, is determined to be the key intended to be activated by the user. The control unit is then configured to communicate to an input control circuit a signal representing input only of key D. By means of the invention, accidental simultaneous activation of more than one key on a keyboard is thereby filtered and analyzed such input of only one key is determined.

It should be noted that the keys in an interface configured in accordance with the invention, e.g. as illustrated in FIGS. 1 or 2, need not be physically separate keys. In an alternative embodiment, the areas representing keys as shown in FIG. 2 may be presented fields on a touch-sensitive display. Furthermore, touch-sensitive elements may be employed also in an embodiment with separate keys, for detection of input or for sensing the influence degree on the key, or both.

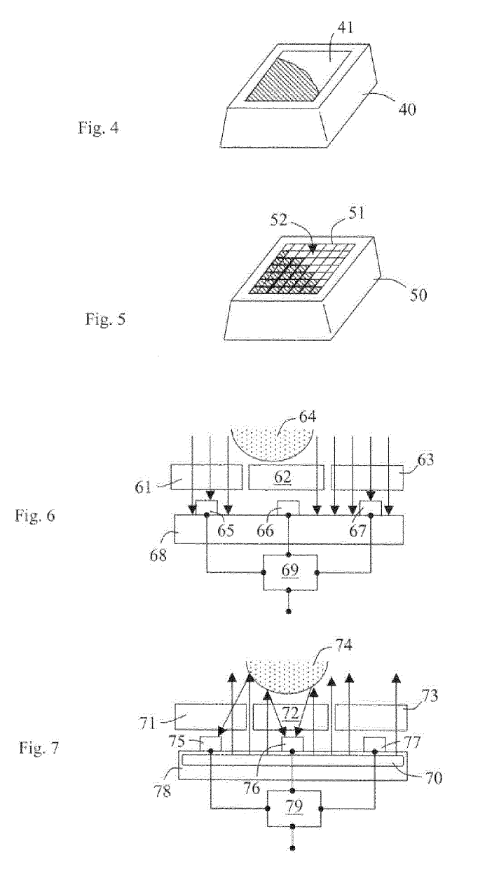

FIG. 4 schematically illustrates a key 40 incorporating a sensor. As mentioned, even though key 40 is illustrated as a typical physical push-button key, the sensor may indeed form a defined surface area of a larger touch-sensitive surface. In the embodiment of FIG. 4, the sensor includes a touch-sensitive element 41 on the upper surface of key 40, coupled to a detection circuit (not shown). The detection circuit is configured to generate a signal which is dependent on a sensed level of user-induced contact to the key. Contact may be accomplished by using a fingertip, or e.g. by using a stylus. However, when a stylus is used it is generally less of an issue to accidentally hit more than one key, and the embodiment of FIG. 4 will therefore be described as being activated with the fingertip of a user. The dashed portion of FIG. 4 represents the influenced portion, i.e. the touched portion of element 41. The detection circuit is in one embodiment configured to generate a signal which is dependent on a sensed impedance between the touch-sensitive element 41 and an object applied in contact with the key, in this case the fingertip. In reality, there are different ways of creating touch-sensitivity. FIG. 4, however, illustrates an embodiment in which the capacitance sensed by the sensor is proportional to the surface area of the touched portion of element 41. Therefore, the larger the touched portion is, the stronger the signal generated by the detection circuit is. Alternatively, the opposite relation exists, where the signal decreases when the touched area portion increases. This is a matter of pure electric circuit design, the choice of which is as such irrelevant to the invention. Another embodiment may employ a resistive touch-sensitive element 41, e.g. including a two closely suspended sheets carrying perpendicular conductive strings, which are placed in contact with each other at various point upon pressing the element 41. Established connections between the two sheets are then e.g. combined to add to a total current passed through the sheets, which is measured by the detection circuit.

FIG. 5 illustrates a key 50 of an alternative embodiment, comprising a sensor. The sensor includes a touch-sensitive element 51 on the upper surface of key 50, coupled to a detection circuit (not shown). However, in this embodiment the touch-sensitive element 51 includes a plurality of pixels or segments 52, separately capable of sensing the touch of e.g. a user fingertip, a stylus, or other object. In a preferred version of this embodiment, each segment 52 has a binary mode function, meaning that either it senses contact or it does not. However, by combining information of the state of each segment 52, the detection circuit is configured to generate a signal having a level which is dependent on the number of segments sensing contact to the key. The segments which are dashed represent the segments sensing contact, i.e. the touched portion of element 51. As above, the touch-sensitivity may be capacitive or resistive, and the signal generated have a level either increasing or decreasing with the number of segments 52 sensing contact.

FIG. 6 illustrates an embodiment of the invention, in which the sensor for sensing user-induced influence on a key is a light sensor. Each light sensor comprises a light-sensitive element in each key and a detection circuit configured to generate a signal which is dependent on a sensed level of user-induced coverage of the light-sensitive element. The drawing illustrates schematically three adjacent keys 61-63. A user-controlled object 64, such as a fingertip, is held over the keyboard, mainly over middle key 62 but also slightly over left key 61. Under each key is a separate light sensor 65-67, such as a number of photo diodes. A support surface 68 for the keys is also illustrated. In this embodiment, each key is made sensitive to incoming light, as exemplified by the arrows in the drawing. In a preferred embodiment, the light sensors are narrow band sensors, such that they are sensitive to a predetermined wavelength range, preferably in the visible region. The keys are therefore made of a material which is transparent to the selected wavelength range. Object 64, however, shades light sensor 66 from incoming light, which is read by the detection circuit connected to the light sensitive element of sensor 66. Sensors 65 and 67, on the other hand, are still exposed to light and will therefore yield a different signal level. The drawing is of course highly schematic, and in reality the light sensors will sense not only light incoming at a straight angle as suggested by the arrows. This means that the shading factor of object 64 will in fact not be binary as indicated in the drawing. Instead, the scenario of FIG. 6 will result in the detection circuit of light sensor 66 generating the lowest signal level, but at least some light will be sensed by scattering from the environment. Sensor 65 will receive more light, and a higher level signal will therefore be generated for key 61 than for key 62. Key 63, however, is least covered or shaded, and the detection circuit of sensor 67 will therefore generate the highest signal. If, when a user as represented by object 64 in FIG. 6 intends to activate key 62, also simultaneously activates key 61 and possibly key 63, the signals generated by the detection circuits of light sensors 65-67 will indicate that key 62 is the one most likely to be intended for input by the user. A comparison between the signals from the different sensors 65-67 is performed by a control unit 69, which then communicates a signal representing input only of key 62 to an input control circuit (not shown).

FIG. 7 illustrates an alternative embodiment, also making use of light sensors. Again, each light sensor comprises a light-sensitive element in each key and a detection circuit configured to generate a signal which is dependent on a sensed level of user-induced coverage of the light-sensitive element. However, in this embodiment a light source is also included. The light-sensitive element of the sensor arranged in each key is configured to sense light originating from the light source reflected in a surface covering the light-sensitive element. Therefore, the light sensors are preferably sensitive to a wavelength emitted by the light source. Furthermore, the keys are made of a material which is transparent to the selected wavelength range. The wavelength, or wavelength range, may be visible, ultraviolet or infrared. The drawing illustrates three adjacent keys 71-73. A user-controlled object 74, such as a fingertip, is held over the keyboard, mainly over middle key 72. Under each key is a separate light sensor 75-77, such as a number of photo diodes. A support surface 78 for the keys carries a light source 70, configured to emit light out from the user input. The light may be used as background light to the user input, and source 70 can e.g. be a Polymer Light Emitting Diode PLED, or an Organic Light Emitting Diode OLED. The PLED or OLED is a backlighting, illumination and display technology which has had an enormous development during recent years, and comprises a thin layer of polymer, preferably an undoped conjugated polymer, which is sandwiched between an anode and a cathode. The polymer of layer emits light when exposed to electricity. When electrons e⁻ and holes h⁺ are injected respectively from cathode and anode into the molecular polymer layer or layers by means of a bias voltage supplied by a DC driver unit, these two types of carriers migrate towards each other and a fraction of them recombine to form light emission. The light from light source 70 is emitted at all angles, and not only at the straight angle indicated by means of arrows in the drawing for the sake of simplicity. When object 74 is held as indicated, light emanating from light source 70 will reflect in the surface of object 74, and a certain amount of the reflected light will hit the light-sensitive element of sensor 76, thereby sensing user-induced influence on key 72. Theoretically, light impinging on object 74 may also be reflected to sensors 75 and 77. However, a field of view (FOV) limiting mechanism is preferably incorporated in each light sensor 75-77, such that only light within a predetermined FOV can be detected. Such limiting mechanism may simply be a cylindrical pipe, at the bottom of which the light-sensitive element is positioned. The walls of the cylinder will then prevent light from reaching the light-sensitive element at angles exceeding the FOV. Another alternative is to place a lens over the light sensitive element. Regardless of the specific solution, the light sensors 75-77 are arranged to sense light, and in particular light reflected by an object placed onto or close to keys 71-73. The position of the reflecting object 74, i.e. the extent to which it covers the respective key, determines the amount of light reflected back to the sensors 75-77. The more incoming light, the higher the signal generated by the detection circuit connected to the light sensitive element of the sensor in question. In the case illustrated in FIG. 7, the strongest signal is generated for middle key 72, a weaker signal for key 71, and an even weaker or no signal at all for key 73. Some light will basically always be detected, from ambient light sources or the sun, or by reflection in the surface layers of the keys. A threshold function for detecting true user-induced influence is therefore preferably included in the detection circuits. If, when a user as represented by object 74 in FIG. 7 intends to activate key 72, also simultaneously activates key 71 and possibly key 73, the signals generated by the detection circuits connected of light sensors 75-77 will indicate that key 72 is the one most likely to be intended for input by the user. Control unit 79 therefore communicates a signal representing input only of key 72 to an input control circuit (not shown).

In yet an alternative embodiment, not shown, each key may comprise a plurality of light-sensitive elements corresponding to the touch-sensitive elements of FIG. 5.

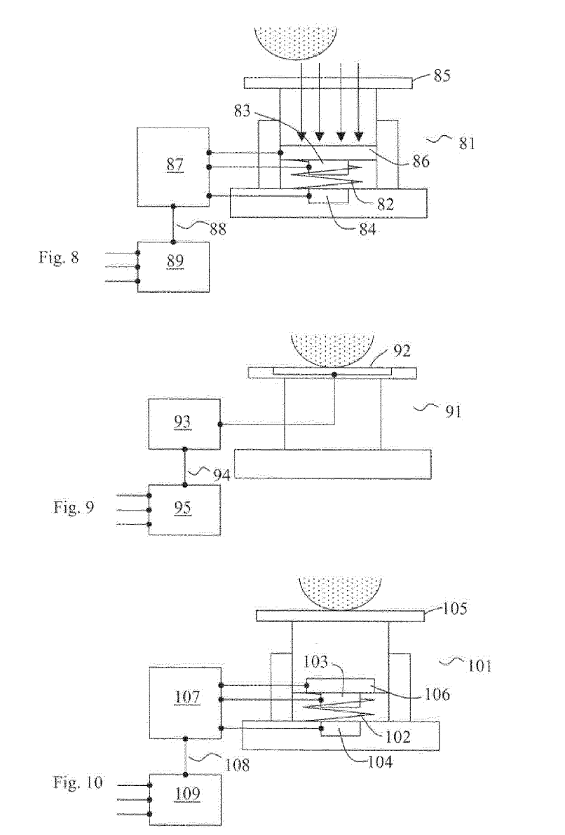

The embodiments of FIGS. 4-7 have described only with reference to the function of the sensor for detecting a level or degree of user-induced influence, but not detection of user activation as such. FIGS. 8-10 illustrate three different embodiment, and shows both the function of user input detection and the function of sensing a level of user-induced influence. The drawings of FIGS. 8-10 are merely schematic, but are helpful for understanding how the same or different sensitive elements can be user for the input detector and the sensor for sensing the level of influence.

FIG. 8 illustrates a key 81 of a user input interface configured in accordance with an embodiment of the invention. Key 81 is a push-button type key, which is schematically illustrated by means of a spring 82, biased to separate to contact elements 83,84. A top portion 85 of the key is displaceable in relation to a support portion, e.g. carried on a PCB. Top portion 85 is transparent to light of a predetermined wavelength range, as illustrated by arrows, and carries a light-sensitive element 86. For the same of simplicity, a common circuit unit 87 is illustrated as including the different circuits need for carrying out the invention, even though they may in reality be separate circuits. First of all, an input detector circuit is included in circuit unit 87, capable of detecting contact between contact elements 83,84, thereby being sensitive to detect user activation. A detecting circuit coupled to light-sensitive element 86 is also included in circuit unit 87, together forming the sensor configured to generate a signal responsive to a sensed level of user-induced influence on key 81. A lead 88 connects circuit unit 87 to a control unit 89, also connected to other keys of a common keyboard. Lead 88 may be a parallel lead comprising one connector lead for transmitting a signal indicating detected input, and one signal generated to reflect a sensed level of user-induced influence. Alternatively, lead 88 may be a single lead for serial communication with control unit 89. Control unit 89 is configured to compare the generated signals for a number of keys detected to be simultaneously activated by a user, and to determine which one of said number of keys is user-selected for input based on the comparison. Typically, the key determined to be user-selected is a key for which a maximum or minimum signal level value is registered, according to a predetermined criterion. If light-sensitive element 86 is configured to sense the degree of shading of the key, a minimum signal value typically represents the user-selected key. If, on the other hand, a light source is also included under key 81, as in FIG. 7, the maximum signal level typically represents the user-selected key.

FIG. 9 illustrates a key 91 of a user input interface configured in accordance with another embodiment of the invention. Key 91 is a touch-sensitive type key, carried a support structure, e.g. a PCB. Key 91 is schematically illustrated by means of a non-displaceable key surface on which a touch-sensitive element 92 is disposed. As mentioned, the touch-sensitive element 92 may be configured to detect input by registering a change in capacitance or resistance by means of a circuit contained in circuit unit 93. Furthermore, touch-sensitive element 92 is also used for the sensor configured to generate a signal responsive to a sensed level of user-induced influence on key 91. For this purpose, circuit unit 93 also includes a detecting circuit coupled to touch-sensitive element 92. The sensor function for generating a signal responsive to a sensed level of user-induced influence may be devised as described with reference to FIG. 4 or 5. A lead 94 connects circuit unit 93 to a control unit 95, also connected to other keys of a common keyboard. Control unit 95 is configured to compare the generated signals for a number of keys detected to be simultaneously activated by a user, and to determine which one of said number of keys is user-selected for input based on the comparison. Typically, the key determined to be user-selected is a key for which a maximum or minimum signal level value is registered, according to a predetermined criterion.

FIG. 10 illustrates a key 101 of a user input interface configured in accordance with another embodiment of the invention. Key 101 is a push-button type key, which is schematically illustrated by means of a spring 102, biased to separate to contact elements 103,104. A top portion 105 of the key is displaceable in relation to a support portion, e.g. carried on a PCB. An input detector circuit is included in circuit unit 107, capable of detecting contact between contact elements 103,104, thereby being sensitive to detect user activation. A pressure-sensing element 106 is also carried in top portion 105, or alternatively in the support portion. Pressure-sensing element 106 is configured to detect an applied pressure on top portion 105 of key 101, and may e.g. include a piezo-electric element. A detecting circuit coupled to pressure-sensitive element 106 is also included in circuit unit 107, together forming the sensor configured to generate a signal responsive to a sensed level of user-induced influence on key 101. A lead 108 connects circuit unit 107 to a control unit 109, also connected to other keys of a common keyboard. As for the embodiment described with reference to FIG. 8, lead 108 may be a serial lead or a parallel lead. Control unit 109 is configured to compare the generated signals for a number of keys detected to be simultaneously activated by a user, and to determine which one of said number of keys is user-selected for input based on the comparison. Typically, the key determined to be user-selected is a key for which a maximum or minimum signal level value is registered, according to a predetermined criterion.

The embodiments shown in FIGS. 8-10 are meant to illustrate three plausible ways of realizing the invention, where at the moment the embodiment of FIG. 9 appears to represent the best mode for carrying out the invention. However, it should be realized that different configurations and methods of operation have been described for both detecting input, using touch-sensitivity or galvanic contact, and for sensing a level of user-induced influence on the key, using an optical solution, a touch-sensitive capacitive or resistive solution, or a pressure-sensing solution. Furthermore, any of the presented solutions for detecting input can be combined with any of the presented solutions for sensing the level of user-induced influence, for creating a solution for overcoming the problem of simultaneous key activation when only one key is to be activated.

The foregoing has described the principles, preferred embodiments and modes of operation of the present invention. However, the invention should not be construed as being limited to the particular embodiments discussed above, which should be regarded as illustrative rather than restrictive, and it should be appreciated that variations may be made in those embodiments by workers skilled in the art without departing from the scope of the present invention, as defined by the following claims.

What is claimed is:

1. A user interface for an electronic device, comprising:
a plurality of keys arranged in proximity to each other, each key comprising an input detector sensitive to detect user activation;
a sensor configured to generate a signal responsive to a sensed level of user-induced influence on each one of the keys;
a control unit configured to compare the generated signals for a number of keys simultaneously activated by a user, and to determine which one of said number of keys is user-selected for input based on the comparison.

2. The user interface of claim 1, wherein the sensor comprises a touch-sensitive element in each key and a detection circuit configured to generate a signal which is dependent on a sensed level of user-induced contact to the key.

3. The user interface of claim 2, wherein the detection circuit is configured to generate a signal which is dependent on a sensed impedance between the touch-sensitive element and an object applied in contact with the key.

4. The user interface of claim 2, wherein the detection circuit is configured to generate a signal which is dependent on a sensed capacitance between the touch-sensitive element and an object applied in contact with the key.

5. The user interface of claim 4, wherein the control unit is configured to determine that the user has selected the key generating a signal representing the highest capacitance.

6. The user interface of claim 2, wherein the detection circuit is configured to generate a signal which is dependent on a sensed electric resistance between the touch-sensitive element and an object applied in contact with the key.

7. The user interface of claim 6, wherein the control unit is configured to determine that the user has selected the key generating a signal representing the lowest electrical resistance.

8. The user interface of claim 1, wherein the sensor comprises a light-sensitive element in each key and a detection circuit configured to generate a signal which is dependent on a sensed level of user-induced coverage of the light-sensitive element.

9. The user interface of claim 8, wherein the control unit is configured to determine that the user has selected the key generating a signal representing the largest extent of coverage.

10. The user interface of claim 8, wherein the sensor further comprises a light source, and where the light-sensitive element in each key is configured to sense light originating from the light source reflected in a surface covering the light-sensitive element.

11. The user interface of claim 1, wherein the sensor comprises a pressure-sensitive element in each key and a detection circuit configured to generate a signal which is dependent on a sensed level of user-induced pressure to the key.

12. The user interface of claim 11, wherein the control unit is configured to determine that the user has selected the key generating a signal representing the largest pressure.

13. The user interface of claim 1, wherein the input detector comprises a switch operable by pressing the key, and a circuit connected to the switch configured to detect user activation.

14. The user interface of claim 1, wherein the input detector comprises a switch operable by touching a touch-sensitive element of the key, and a circuit connected to the switch configured to detect user activation.

15. The user interface of claim 1, wherein the control unit is configured to determine that the key for which the signal has an extreme value among the number of keys is the one key user-selected for input.

16. The user interface of claim 1, wherein the control unit is configured to send a user input signal to the electronic device representing the key determined to be user-selected for activation.

17. A user interface for an electronic device, comprising:
a plurality of keys arranged in proximity to each other, each key comprising an input detector sensitive to detect user activation;
a touch-sensitive element in each one of the keys, configured to generate a signal responsive to a sensed level of contact between each key and a user touching the key;
a control unit configured to compare the generated signals for a number of keys simultaneously activated by a user, and to determine which one of said number of keys is user-selected for input based on the comparison.

18. A user interface for an electronic device, comprising:
a plurality of keys arranged in proximity to each other, each key comprising an input detector sensitive to detect user activation;
a light-sensitive element in each one of the keys, configured to generate a signal responsive to a sensed level of coverage by a user of each key;
a control unit configured to compare the generated signals for a number of keys simultaneously activated by a user, and to determine which one of said number of keys is user-selected for input based on the comparison.

19. A user interface for an electronic device, comprising:
a plurality of keys arranged in proximity to each other, each key comprising an input detector sensitive to detect user activation;
a pressure-sensitive element in each key, configured to generate a signal responsive to a sensed level of pressure applied by a user on the key;
a control unit configured to compare the generated signals for a number of keys simultaneously activated by a user, and to determine which one of said number of keys is user-selected for input based on the comparison.

20. A method for operating a user interface for an electronic device, comprising:
detecting simultaneous user activation of a number of keys arranged in proximity to each other;
generating a signal responsive to a sensed level of user-induced influence on each one of the number of keys;
comparing the generated signals for the number of keys simultaneously activated by a user; and
determining which one of said number of keys is user-selected for input based on the comparison.

21. The method of claim 20, comprising the step of:
comparing a magnitude level for the generated signals, the magnitude level for each key representing a level of contact between the user and the key.

22. The method of claim 20, comprising the step of:
comparing a magnitude level for the generated signals, the magnitude level for each key representing a level of coverage of the user on the key.
